(19) United States
(12) Patent Application Publication
(10) Pub. No.: US 2025/0362221 A1
(43) Pub. Date: Nov. 27, 2025

(54) CALIBRATION KIT FOR RETARDING ENERGY ANALYZER SENSORS

(71) Applicant: Applied Materials, Inc., Santa Clara, CA (US)

(72) Inventors: AMIR BAYATI, San Jose, CA (US); ANKE HELLMICH, Kahl (DE); SVEN SCHRAMM, Kahl (DE); CHRISTOPHER MALMS, Hanau Hessen (DE); LINDSAY HARDISON, Newport, NC (US); SUHAS UMESH, Sunnyvale, CA (US)

(21) Appl. No.: 18/674,470

(22) Filed: May 24, 2024

(51) Int. Cl. G01N 21/27; G01N 23/2273

(52) U.S. Cl. CPC G01N 21/274; G01N 23/2273

(57) ABSTRACT

Some embodiments described herein relate to a method of calibrating a device sensor that includes inserting a reference sensor into a calibration system. In an embodiment, the calibration system includes a light source, and a photonic detector. In an embodiment, the method further includes measuring a reference transmission value of an amount of light from the light source that is transmitted through the reference sensor towards the photonic detector, and inserting the device sensor into the calibration system. In an embodiment, the method further includes measuring a transmission value of the amount of light from the light source that is transmitted through the device sensor towards the photonic detector, and calculating a scaling factor for the device sensor. In an embodiment, the scaling factor equalizes the transmission value of the device sensor to the reference transmission value of the reference sensor.

### BACKGROUND

### 1) Field

Embodiments of the present disclosure pertain to the field of calibration systems for retarding energy analyzer sensors.

### 2) Description of Related Art

Plasma processing operations are used throughout the manufacture of semiconductor devices. However, monitoring the properties of the plasma is difficult. For example, properties, such as electron density, ion flux, and/or ion energy distribution are useful for determining the performance of a given processing operation. When plasma properties are well known for a given process, it is easier to optimize the process.

Currently, plasma properties are determined through the use of devices such as a retarding field energy analyzer (RFEA). An RFEA includes a series of conductive screens that are applied in a stack. The screens are each held at different voltages in order to allow for ions with a specific energy to reach a collector plate. The current generated in the collector plate can be used to determine one or more of the plasma properties under investigation. However, RFEA solutions have significant limitations.

### SUMMARY

Some embodiments described herein relate to a method of calibrating a device sensor that includes inserting a reference sensor into a calibration system, where the calibration system. In an embodiment, the calibration system includes a light source, and a photonic detector. In an embodiment, the method further includes measuring a reference transmission value of an amount of light from the light source that is transmitted through the reference sensor towards the photonic detector, and inserting the device sensor into the calibration system. In an embodiment, the method further includes measuring a transmission value of the amount of light from the light source that is transmitted through the device sensor towards the photonic detector, and calculating a scaling factor for the device sensor. In an embodiment, the scaling factor equalizes the transmission value of the device sensor to the reference transmission value of the reference sensor.

Embodiments described herein relate to a method for measuring a plasma property with a sensor device that includes inserting the sensor device for measuring the plasma property into a chamber. In an embodiment, the sensor device includes a sensor. The method may further include measuring an ion transmission value with the sensor, and applying a scaling factor to the ion transmission value. In an embodiment, the scaling factor is determined through a calibration process.

Embodiments described herein relate to an apparatus that includes a plurality of plates that are electrically conductive. In an embodiment, each of the plurality of plates includes a grid of openings, where the plurality of plates are arranged in a stack, and where the plurality of plates are electrically insulated from each other. In an embodiment, a board is detachably coupled to the plurality of plates, and the board is coupled to a collector plate that is electrically conductive.

### BRIEF DESCRIPTION OF THE DRAWINGS

FIG. 1A is a plan view illustration of a sensor with openings at a center of the sensor, in accordance with an embodiment.

FIG. 1B is a plan view illustration of a sensor with openings at an edge of the sensor, in accordance with an embodiment.

FIG. 1C is a plan view illustration of a sensor substrate with a plurality of sensors across a surface of the sensor substrate, in accordance with an embodiment.

FIG. 2A is a cross-sectional illustration of a sensor, in accordance with an embodiment.

FIG. 2B is a cross-sectional illustration of a sensor with a backside removed, in accordance with an embodiment.

FIG. 3 is a perspective view illustration of a calibration system for calibrating sensors, in accordance with an embodiment.

FIG. 4A is a cross-sectional schematic illustration of a calibration system with a sensor that comprises a removed backside, in accordance with an embodiment.

FIG. 4B is a cross-sectional schematic illustration of a calibration system with a light source and a photo detector on the same side of the sensor, in accordance with an embodiment.

FIG. 5 is a plan view illustration of a tool that is monitored with a sensor substrate, in accordance with an embodiment.

FIG. 6 is a process flow diagram of a process for calibrating a sensor, in accordance with an embodiment.

FIG. 7 is a process flow diagram of a process for measuring a plasma property in a chamber with a calibrated sensor, in accordance with an embodiment.

FIG. 8 illustrates a block diagram of an exemplary computer system of a processing tool, in accordance with an embodiment of the present disclosure.

### DETAILED DESCRIPTION

Calibration systems for retarding field energy analyzer sensors are disclosed herein, in accordance with various embodiments. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, retarding field energy analyzers (RFEA) are limited in several ways. One limitation is that exposure to plasma environments rapidly degrades the performance of the RFEA. For example, the plasma environment may result in erosion of the grids of each plate of the RFEA and/or deposition of material onto the grids of each plate of the RFEA. Such changes may result in an increase and/or decrease in the dimensions of the openings in the grids. This can alter the transmission rate of ions through the RFEA. Accordingly, the calibration of the RFEA can degrade quickly. Further, when multiple RFEAs are provided on a single sensor substrate, operation of individual RFEAs can change at different rates.

Typically, plasma systems are used to recalibrate the RFEAs. This has several disadvantages. For example, the use of plasma based calibration systems can further erode the plates within the RFEA. This reduces the lifespan of the RFEAs. A plasma based recalibration process also has a long duration. The RFEA must be inserted into the plasma chamber, the chamber is pumped down, the recalibration is implemented, and then the plasma chamber needs to be vented. This process may also require highly trained technicians or engineers. Since RFEAs need recalibration often, this process is can become costly and time consuming.

Accordingly, embodiments disclosed herein include a calibration system that uses optical sensing. It has been shown that optical transmission through the RFEA can be correlated to ion transmission through the RFEA. As such, an optical test bench can be used in order to measure an optical transmission through the RFEA, and the optical transmission can be correlated to an ion transmission. Optical calibration systems are simpler to implement and allows for faster and less expensive calibration of the RFEAs. For example, a technician with minimal training can implement the calibration process. Further, since plasma environments are not needed, the testing can be implemented without further damage to the RFEA.

In an embodiment, the optical calibration system may comprise a light source and a photonic detector. The RFEA is placed between the light source and the photonic detector. A measure of the amount of light that passes through the RFEA is used to determine an optical transmission value. The optical transmission value is compared to a reference optical transmission value of a reference RFEA that is measured by the same optical calibration system. A scaling factor is applied to the optical transmission value in order to align the optical transmission value with the reference optical transmission value. Accordingly, any degradation in performance of the RFEA can be scaled in order to obtain an accurate measure of ion transmission during subsequent plasma sensing.

In an embodiment, the RFEA may have a modified structure in order to be compatible with the optical calibration system. Typically, the RFEA has a closed backend. For example, a collector plate over a board is provided on an end of the RFEA opposite from the end with the opening to the conductive plates. Removal of the collector plate and the board allows for optical signal to pass through the RFEA. That is, light from the light source passes through the RFEA, and the light is detected by the photonic detector. The RFEA may be designed so that the backend can be removed for calibration. The backend can then be replaced after calibration in some embodiments.

In other embodiments, the calibration system may be set up so that the light source and the photonic detector are on the same side of the RFEA. In such an embodiment, light from the light source passes into the RFEA, reflects off of the collector plate, and is transmitted back through the RFEA to the photonic detector. In such an embodiment, the RFEA may not need any unique design to accommodate the calibration system.

Embodiments disclosed herein may also include calibration systems with additional components in order to improve the accuracy of the calibration. For example, a collimating lens and a filter may be provided along the optical path of the calibration system. An aperture may be provided between the light source and the RFEA in another embodiment. An additional aperture may be provided between the RFEA and the photonic detector in other embodiments.

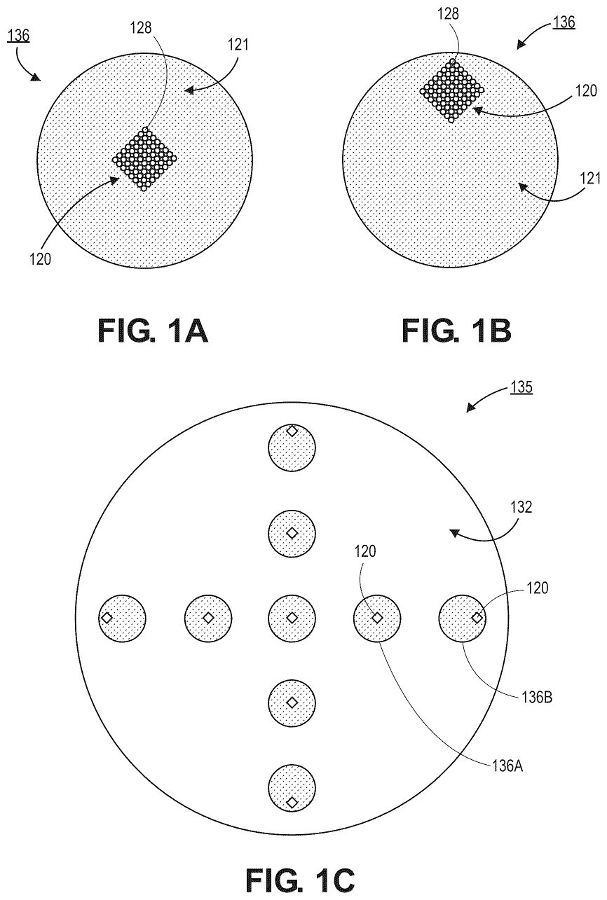

Referring now to FIGS. 1A-1C, a series of plan view illustrations that show sensors 136 (FIGS. 1A and 1B) and a sensor device 135 (FIG. 1C) is shown, in accordance with an embodiment. The difference between the sensors 136 in FIGS. 1A and 1B is the location of the group 120 of holes 128. FIG. 1C illustrates an example of how different sensor 136 layouts can be leveraged within a single senor device 135 for improved sensing coverage. In an embodiment, the sensors 136 may be RFEA sensors 136.

Referring now to FIG. 1A, a plan view illustration of an RFEA sensor 136 is shown, in accordance with an embodiment. In an embodiment, the RFEA sensor 136 may comprise a top housing 121. In an embodiment, a group 120 of holes 128 may be provided on the housing 121 (e.g., the top surface of the housing 121). In the illustrated embodiment, the group 120 is substantially centered at a center point of the top surface of the housing 121. Such an RFEA sensor 136 may be referred to as a symmetric RFEA sensor 136. The holes 128 may be openings into an interior of the RFEA sensor 136 that includes a plurality of electrically conductive plates (not shown) that have a grid of openings for allowing ions (or light) to pass through the interior of the RFEA sensor 136. The internal construction of the RFEA sensor 136 will be described in greater detail below.

Referring now to FIG. 1B, a plan view illustration of an RFEA sensor 136 is shown, in accordance with an embodiment. In an embodiment, the RFEA sensor 136 may comprise a top housing 121. In an embodiment, a group 120 of holes 128 may be provided on the housing 121 (e.g., the top surface of the housing 121). In the illustrated embodiment, the group 120 is substantially off-center from a center point of the top surface of the housing 121. Such a sensor 136 may be referred to as an asymmetric RFEA sensor 136. As shown, the group 120 includes holes 128 that are proximate to an outer edge of the sensor 136. This can allow for improved edge detection, as will be described in greater detail below.

Referring now to FIG. 1C, a plan view illustration of a sensor device 135 is shown, in accordance with an embodiment. In an embodiment, the sensor device 135 may comprise a plurality of RFEA sensors 136 distributed across a lid 132 of the sensor device 135. The sensor device 135 may have a form factor similar to substrates that are processed within a plasma processing tool. For example, the sensor device 135 may have a wafer form factor (e.g., 200 mm, 300 mm, 450 mm, etc.), or a panel form factor.

The sensors 136 may include symmetric sensors 136A and asymmetric sensors 136B. The symmetric sensors 136A may have groups 120 of holes (not individually shown) that are at a center of the symmetric sensors 136A. The asymmetric sensors 136B may have groups 120 of holes that are at the outer edge of the asymmetric sensors 136B. Further, the asymmetric sensors 136B are oriented so that the groups 120 are proximate to the outer edge of the lid 132. This allows for plasma properties to be sensed even closer to the edge of the sensor device 135. This is useful since edge effects are often difficult to control and predict, and having information about the plasma process proximate to the edge of a wafer can be particularly beneficial.

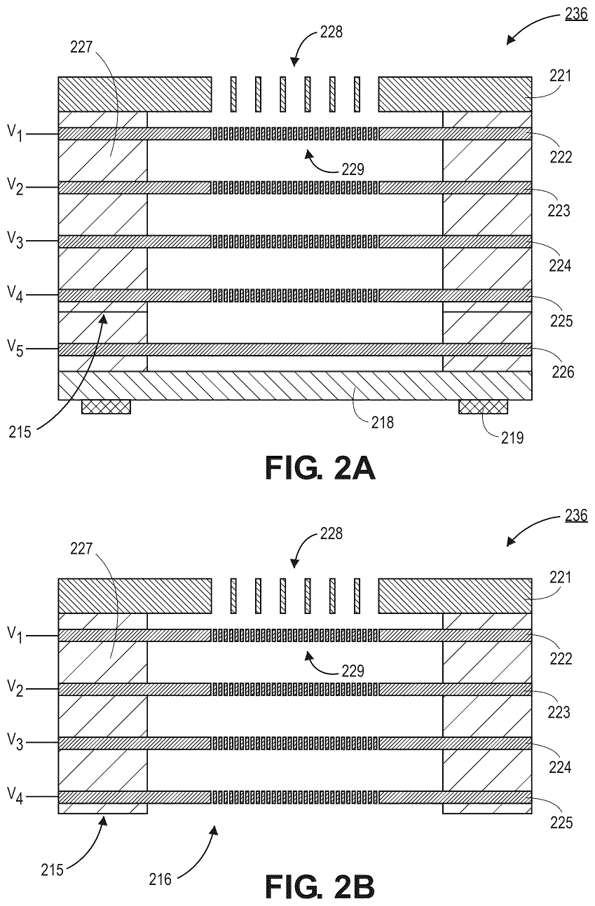

Referring now to FIGS. 2A and 2B, cross-sectional illustrations of an RFEA sensor 236 are shown, in accordance with various embodiments. FIG. 2A is an illustration of the RFEA sensor 236 when the backside is assembled to allow for ion sensing. FIG. 2B is an illustration of the RFEA sensor 236 when the backside is removed to allow for calibration.

Referring now to FIG. 2A, a cross-sectional illustration of a sensor 236 is shown, in accordance with an embodiment. In an embodiment, the sensor 236 may be an RFEA sensor 236. The RFEA sensor 236 may comprise a housing 221 with one or more holes 228. The holes 228 may allow species from the plasma (not shown) to pass into an interior of the RFEA sensor 236. In an embodiment, the interior of the RFEA sensor 236 may comprise a plurality of electrically conductive plates 222, 223, 224, and 225 that are arranged in a stack. The plates may each be held at different voltages V₁-V₄. A collector plate 226 may be provided at a bottom of the plate stack, and the collector plate 226 may be held at a voltage V₅. The plates 222-225 and the collector plate 226 may be separated from each other by electrically insulating layers 227.

In an embodiment, the top plate 222 may be used to prevent plasma formation within the RFEA sensor 236. The next plate 223 may be an electron repulsion screen. The plate 223 repels electrons by having a voltage V₂ that is negative. The next plate 224 may be a discriminator screen that controls the flow of electrons to the collector plate 226. In some embodiments, the third voltage V₃ may be scanned between a range in order to control the flow of ions through the RFEA sensor 236. The bottom plate 225 may be a secondary electron suppression screen. The voltage V₄ may be negatively biased with respect to the voltage V₅ of the collector plate 226 to create a retarding potential for repelling secondary electrons that are generated from the impact of ions with the collector plate 226.

In the embodiment shown in FIG. 2A, the holes 229 are provided through the plates 222-225. The holes 229 in each plate 222-225 may be arranged in a grid like pattern in order to allow for ions from the plasma to pass through the RFEA sensor 236. While the RFEA sensor 236 in FIG. 2A has perfectly aligned holes 229 in each plate 222-225, it is to be appreciated that manufacturing limitations may result in misaligned holes 229. Further, degradation through use of the RFEA sensor 236 may change dimensions of the holes 229. As such, calibration processes, such as those described herein can be used in order to provide a more accurate measurement of the plasma conditions in the chamber.

In an embodiment, the collector plate 226 may be coupled to a board 218. The board 218 may include pads 219 that are coupled to the collector plate 226 by vias, traces, and/or the like (not shown). The pads 219 may be coupled to the sensor device (e.g. similar to sensor device 135 described in greater detail above). In some embodiments, the backside of the RFEA sensor 236 is removable in order to allow for calibration in accordance with some embodiments disclosed herein. For example, seam 215 in the electrically insulating layer 227 between the plate 225 and the collector plate 226 may be a location where the backside of the RFEA sensor 236 (e.g., comprising the collector plate 226 and the board 218) can be detached. In an embodiment, the backside of the RFEA sensor 236 may be detachably coupled to the remainder of the RFEA sensor 236 through any suitable mechanism, such as, for example, a snap, a clip, a clamp, a screw, a bolt, a magnet, an adhesive, a frame, and/or the like. As used herein, “detachably coupled” may refer to components that are mechanically secured to each other, while still being able to be detached without damage to the secured components.

Referring now to FIG. 2B, a cross-sectional illustration of the RFEA sensor 236 with the backside removed is shown, in accordance with an embodiment. The removal of the collector plate 226 and the board 218 opens up the end of the RFEA sensor 236 opposite from the holes 228. For example, an opening 216 is provided below the plate 225. Accordingly, light from a light source in a calibration system can pass through the RFEA sensor 236.

As noted above, usage of RFEA sensors may result in degradation through erosion of the plates and/or deposition of material on the plates. This results in changes in the dimension of the openings through the plates (i.e., the grid on each of the plates). The change in dimensions alters the amount of ions that can pass through the RFEA sensor. Accordingly, the measurements of RFEA sensor begin to drift. In some embodiments, a recalibration process may be used to correct the drift of the RFEA sensor.

In some embodiments, the calibration of the RFEA sensor is implemented with an optical calibration system. The use of an optical calibration system allows for the RFEA sensor to be calibrated quickly (e.g., in approximately 5 minutes or less) with technicians that have minimal training. The optical calibration system also has significantly lower costs compared to plasma based calibration options. Further, the optical calibration does not degrade the RFEA sensor, which can prolong the lifespan of the RFEA sensor.

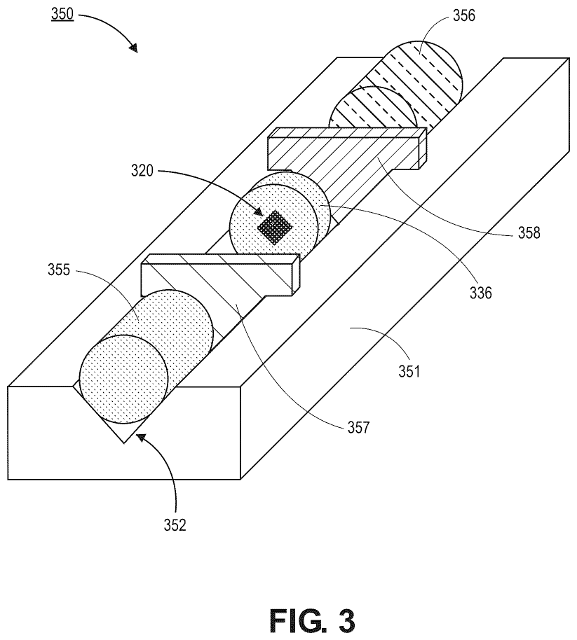

Referring now to FIG. 3, a perspective view illustration of a simplified version of a calibration system 350 is shown, in accordance with an embodiment. In an embodiment, the calibration system 350 may comprise a light source 355 and a photonic detector 356. In an embodiment, the RFEA sensor 336 that is being calibrated is provided along an optical path between the light source 355 and the photonic detector 356. The RFEA sensor 336 may be similar to any of the RFEA sensors described in greater detail herein. In a particular embodiment, a backside of the RFEA sensor 336 (e.g., comprising the collector plate and the board) has been removed in order to allow for light from the light source 355 to pass through a group 320 of holes in the RFEA sensor 336 and through an interior of the RFEA sensor 336 as it is propagated towards the photonic detector 356.

The light source 355 may be any suitable light source for providing optical transmission measurements. For example, the light source 355 may be a narrow band light source (e.g., a laser or light emitting diode (LED)). Though, broad band light sources, such as a light bulb (e.g., a halogen bulb) or the like, may also be used in some embodiments. The light source 355 may also be heated in some embodiments. Generally, a frequency (or a band of frequencies) of the light source 355 may be between 200 nm and 2,000 nm. Though, lower or higher frequencies may also be used. For example, the light source may operate in ultraviolet wavelengths, visible wavelengths, and/or infrared wavelengths. In some embodiments, the light source 355 operates in a continuous mode. Other embodiments may include a light source 355 that can operate in a pulsed mode, which may be beneficial for reducing noise in the calibration system 350. In an embodiment, the photonic detector 356 may be any suitable sensor device for converting photons received by the photonic detector 356 into an electrical signal (e.g., a current or a voltage). For example, the photonic detector 356 may be photo diode, a photo conductor, a thermopile, or the like.

In an embodiment, the calibration system 350 may comprise an alignment block 351 for properly aligning the RFEA sensor 336 between the light source 355 and the photonic detector 356. For example, the alignment block 351 may comprise a groove 352, such as a V-groove. In the illustrated embodiment, the light source 355 and the photonic detector 356 are also provided in the groove 352 of the alignment block 351. Though, in other embodiments, one or both of the light source 355 and/or the photonic detector 356 may be positioned off of the alignment block 351. The alignment block 351 may position the RFEA sensor 336 so that the group 120 of holes (not individually labeled) are within the optical path between the light source 355 and the photonic detector 356.

In an embodiment, the optical calibration system 350 may also comprise a collimating lens (or collimator) 357 between the light source 355 and the RFEA sensor 336. The collimator 357 may be useful for orienting the path of light from the light source 355 into a parallel path through the RFEA sensor 336. This can be used to improve the effectiveness of the calibration system 350 and provide more reliable measurements of the optical transmission through the RFEA sensor 336.

In an embodiment, the optical calibration system 350 may also comprise a filter 358. In an embodiment, the filter 358 may be provided between the RFEA sensor 336 and the photonic detector 356. The filter 358 may include one or more different types of optical filters, such as a long pass filter, a short pass filter, a bandpass filter or the like. The filter 358 may be useful for preventing unwanted wavelengths of light from entering the photonic detector 356. As such, noise in the measurement may be reduced.

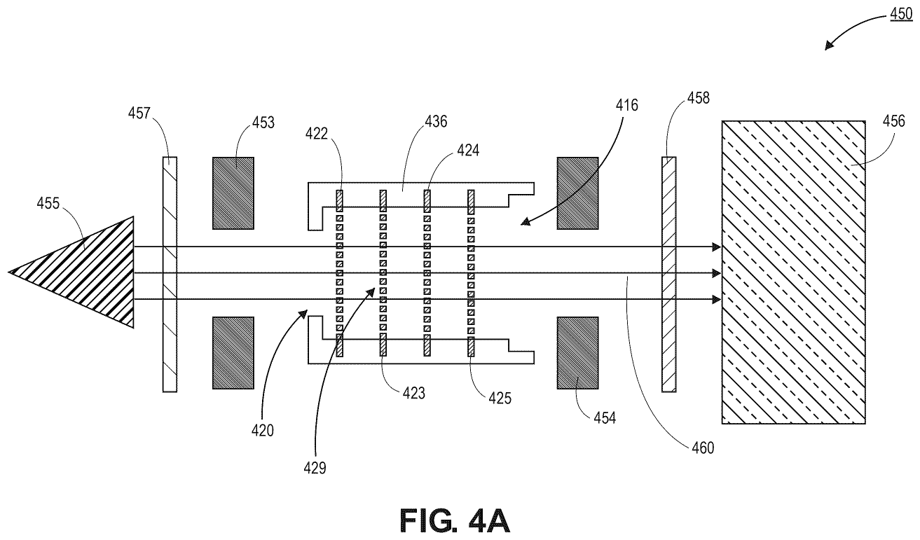

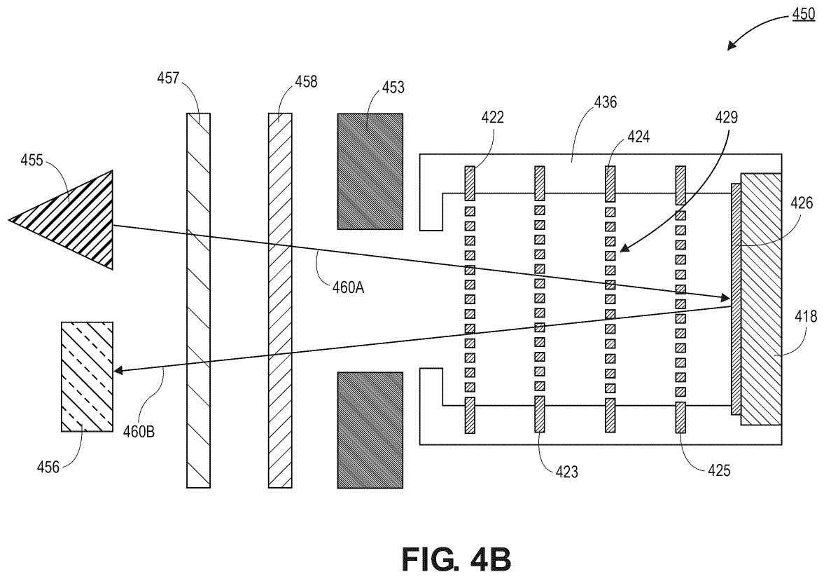

Referring now to FIG. 4A, a cross-sectional schematic of an optical calibration system 450 is shown, in accordance with an embodiment. FIG. 4A illustrates an optical path 460 from the light source 455 to the photonic detector 456 that passes through the RFEA sensor 436. For example, a backside portion of the RFEA sensor 436 is removed to form an opening 416 opposite from the opening 420 that is closest to the light source 455. The RFEA sensor 436 may be similar to any of the RFEA sensors described in greater detail herein. For example, the RFEA sensor 436 comprises a plurality of plates 422-425 that each comprise holes 429 (e.g., a grid) to allow for the light along the optical path 460 to pass through the RFEA sensor 436. In an embodiment, changes to dimensions of the holes 429 (e.g., through erosion or deposition) can alter the amount of light that passes from the light source 455 to the photonic detector 456. In an embodiment, the light source 455 and the photonic detector 456 may be similar to any of the light sources and/or photonic detectors described in greater detail herein.

As shown, the optical calibration system 450 may also comprise a collimator 457 between the light source 455 and the RFEA sensor 436, and an optical filter 458 between the RFEA sensor 436 and the photonic detector 456. The collimator 457 and the optical filter 458 may be similar to any of the collimators and/or optical filters described in greater detail herein. The optical filter 458 may ensure that light with a specific wavelength is detected by the photonic detector 456 in order to eliminate possible noise from background light emission. Additionally, a first aperture 453 may be provided between the light source 455 and the RFEA sensor 436. An opening of the aperture may have a diameter that is smaller than a diameter of the opening 420 in some embodiments. This may be useful for preventing stray light from entering the RFEA sensor 436, and signal noise can be reduced. In some embodiments, a second aperture 454 may be provided between the RFEA sensor 436 and the photonic detector 456.

Referring now to FIG. 4B, a cross-sectional schematic of an optical calibration system 450 is shown, in accordance with an additional embodiment. Instead of having the light source 455 and the photonic detector 456 on opposite ends of the RFEA sensor 436, the light source 455 and the photonic detector 456 may be adjacent to the same end of the RFEA sensor 436. In such an embodiment, the optical path 460 may comprise a first portion 460A from the light source 455 that passes through the RFEA sensor 436 towards a collector plate 426, and a second portion 460B that reflects off of the collector plate 426 and travels back towards the photonic detector 456. In the illustrated embodiment, the first portion 460A and the second portion 460B are angled for illustrative purposes. However, embodiments may include an optical path that is substantially orthogonal to the plates 422-425. Additionally, embodiments may include one or more mirrors (not shown) for routing the optical path between the light source 455 and the photonic detector 456.

In such an embodiment, the RFEA sensor 436 may not need the backside removed to allow the light to pass completely through the RFEA sensor 436. As shown, the board 418 and the collector plate 426 remain on the RFEA sensor 436 during calibration. This may allow for further reductions in the time necessary to make the calibration measurement.

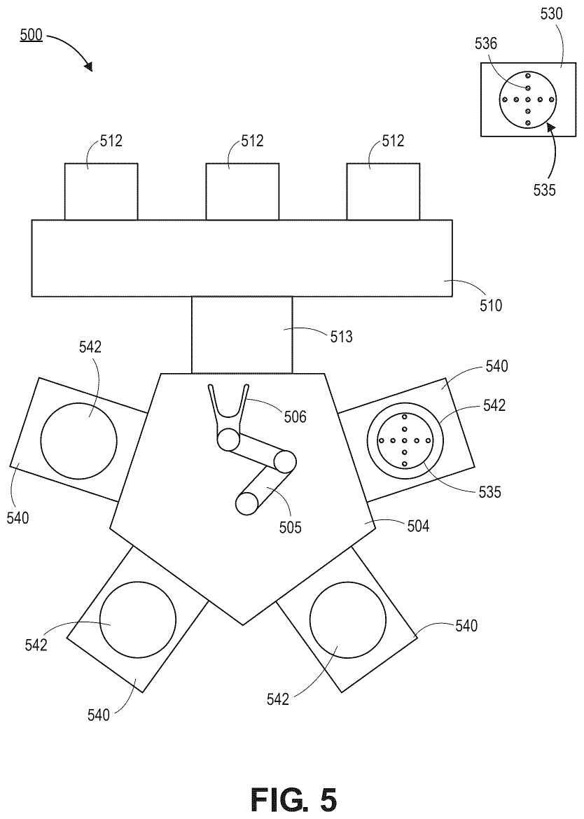

Referring now to FIG. 5 a plan view illustration of a semiconductor processing tool 500 is shown, in accordance with an embodiment. In an embodiment, the semiconductor processing tool 500 may sometimes be referred to as a cluster tool, an inline tool, or the like since there are a plurality of chambers 540 coupled within a single system. The plurality of chambers 540 may all include the same type of chamber, or the plurality of chambers 540 may include two or more different types of chambers. While four chambers 540 are shown, it is to be appreciated that embodiments disclosed herein may be compatible with semiconductor processing tools 500 that comprise one or more chambers 540. In an embodiment, the chambers 540 may include one or more of, a deposition chamber, an etch chamber, a resist deposition (e.g., spin-coating) chamber, an annealing chamber, an exposure chamber (e.g., an ultraviolet exposure tool, such as a deep ultraviolet (DUV) exposure tool, an extreme ultraviolet (EUV) exposure tool, etc.), a resist develop chamber, or the like.

In an embodiment, two or more of the chambers 540 may be coupled to a transfer chamber 504. The transfer chamber 504 may comprise a wafer handling robot 505. The wafer handling robot 505 may be a multi-axis robot device. The wafer handling robot 505 may comprise an end effector 506 or the like to secure and transport wafers or sensor devices 535 between chambers 540. In an embodiment, the transfer chamber 504 may be maintained at a sub-atmospheric pressure, such as a vacuum pressure.

In an embodiment, a load lock 513 may couple the transfer chamber 504 to an equipment front end module (EFEM) 510. The EFEM 510 may couple with one or more front opening unified pods (FOUPs) 512. A robot (not shown) within the EFEM 510 may transfer wafers (or sensor devices 535) between the FOUPs 512 and the load lock 513. The load lock 513 may be a transition between an atmospheric pressure (e.g., in the EFEM 510) and a vacuum pressure (e.g., in the transfer chamber 504).

In an embodiment, one or more sensor devices 535 may be transported within the semiconductor processing tool 500 and the rest of the fab with robotic systems. That is, the sensor devices 535 may be compatible with automated movement through the semiconductor processing tool 500. For example, a sensor device 535 is shown as being supported on a pedestal 542 (e.g., an electrostatic chuck (ESC)) within the first chamber 540 from the load lock 513 (in a clockwise direction). This sensor device 535 may have initially been delivered to the semiconductor processing tool 500 in FOUP 512. The FOUP 512 may have been unloaded by a robot in the EFEM 510, passed through the load lock 513, and moved from the load lock 513 to the chamber 540 by the wafer handling robot 505.

In an embodiment, the sensor device 535 may have a form factor and mass that are similar to a typical wafer handled by the semiconductor processing tool 500 (e.g., a 200 mm wafer, a 300 mm wafer, a 450 mm wafer, etc.). Generally, the sensor device 535 may comprise one or more sensors 536. The sensors 536 may include plasma sensors. In a particular embodiment, the plasma sensors are RFEA sensors, similar to those described in greater detail herein. The sensor device 535 may be similar to any of the sensor devices described in greater detail herein.

In an embodiment, the sensor device 535 may be a battery operated device. Accordingly, the sensor device 535 may be charged after use or after any suitable duration of use. In some embodiments, the charging of the sensor device 535 may be implemented at a docking station 530. The docking station 530 may include structures for coupling to a battery in the sensor device 535 in order to charge the battery. The structures may include a plug, or wireless power delivery solutions (e.g., inductive coils, etc.). The docking station 530 may also include data connection capabilities (e.g., wireless or wired) in order to transfer data to and/or from the sensor device 535. In an embodiment, the docking station 530 may be a stationary device that does not move. In other embodiments, the docking station 530 may be part of a FOUP 512 or other transport device.

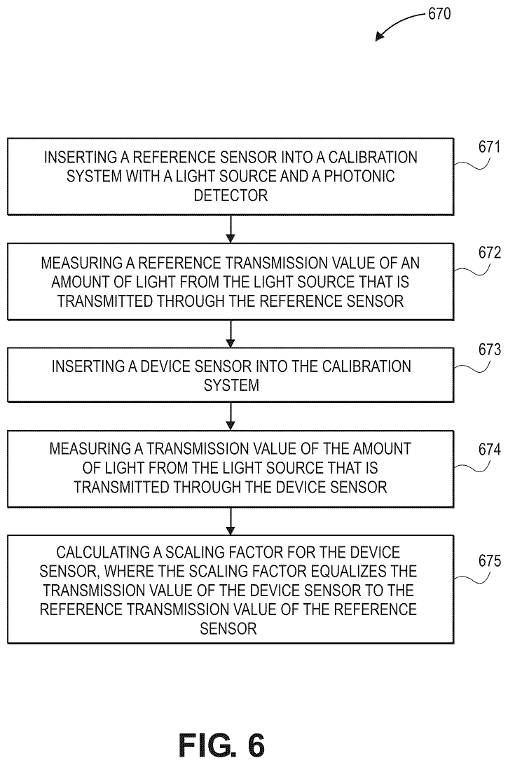

In an embodiment, the sensor device 535 may be periodically taken out of service for maintenance. For example, the sensors 536 may be removed from the sensor device 535 and recalibrated. The recalibration system may be an optical calibration system similar to any of those described in greater detail herein. The recalibration process may be similar to the process described in greater detail with respect to FIG. 6.

Referring now to FIG. 6, a process flow diagram of a process 670 for calibrating a sensor is shown, in accordance with an embodiment. In an embodiment, the process 670 may include calibrating sensors, such as RFEA sensors described in greater detail herein. The calibrating system that is used for the calibration may be similar to any of the calibration systems disclosed in greater detail herein.

In an embodiment, the process 670 may begin with operation 671, which comprises inserting a reference sensor into a calibration system with a light source and a photonic detector. In an embodiment, the reference sensor is between the light source and the photonic detector, similar to the arrangement shown in FIG. 4A. In other embodiments, the reference sensor and the light source are on the same side of the reference sensor, similar to the arrangement shown in FIG. 4B. In an embodiment, the reference sensor may be considered as being a “golden” reference. That is, the reference sensor may be an accurately calibrated sensor. For example, the reference sensor may be a sensor that was obtained from the manufacturer already calibrated, and the reference sensor has not been exposed to a plasma environment after calibration.

In an embodiment, the process 670 may continue with operation 672, which comprises measuring a reference transmission value of an amount of light from the light source that is transmitted through the reference sensor. In an embodiment, the light source may be continuously on during the measurement, or the light source may be pulsed. The reference transmission value may be measured over a duration of up to several minutes. Though, longer durations may also be used in some embodiments. After the reference transmission value is obtained, the reference sensor may be removed from the calibration system.

In an embodiment, the process 670 may continue with operation 673, which comprises inserting a device sensor into the calibration system. In an embodiment, the device sensor is between the light source and the photonic detector, similar to the arrangement shown in FIG. 4A. In other embodiments, the device sensor and the light source are on the same side of the reference sensor, similar to the arrangement shown in FIG. 4B. The device sensor may be structurally similar to the reference sensor, with the exception that the device sensor has been exposed to a plasma environment after a previous calibration. Though, it is to be appreciated that manufacturing tolerances, material property variations, and/or the like may result in at least some differences between the device sensor and the reference sensor.

In an embodiment, the process 670 may continue with operation 674, which comprises measuring a transmission value of the amount of light from the light source that is transmitted through the device sensor. In an embodiment, the measurement conditions used to determine the transmission value for the device sensor may be the same as those used to determine the reference transmission value of the reference sensor.

In an embodiment, the process 670 may continue with operation 675, which comprises calculating a scaling factor for the device sensor. In an embodiment, the scaling factor equalizes the transmission value of the device sensor to the reference transmission value of the reference sensor. For example the scaling factor may be multiplied with the transmission value of the device sensor in order to match the reference transmission value of the reference sensor. The scaling factor can then be associated with the sensor. During subsequent measurements performed by the device sensor, the scaling factor can be applied to the measurement in order to provide a more accurate result.

In the process 670 a single device sensor is calibrated after the reference sensor is measured. However, it is to be appreciated that the reference sensor may be measured to find a reference transmission value, and then a plurality of device sensors can be calibrated based on the single reference transmission value. The reference transmission value can be periodically refreshed. Additionally, embodiments may include the use of a plurality of reference sensors to find an average reference transmission value. That is, each of the plurality of reference sensors may be measured, and the reference transmission values for the plurality of reference sensors can be averaged.

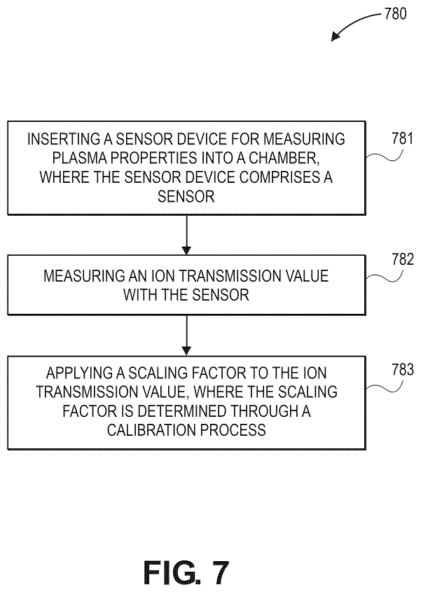

Referring now to FIG. 7, a process flow diagram of a process 780 for using a calibrated sensor is shown, in accordance with an embodiment. In an embodiment, the process 780 may begin with operation 781, which comprises inserting a sensor device for measuring plasma properties into a chamber. In an embodiment, the sensor substrate may comprise one or more sensors. For example, the sensor device may be similar to any of the sensor devices described in greater detail herein. The one or more sensors may be RFEA sensors that are similar to any of the RFEA sensors described in greater detail herein. In an embodiment, the chamber may be similar to a chamber within a tool similar to tool 500 described in greater detail herein.

In an embodiment, the process 780 may continue with operation 782, which comprises measuring an ion transmission value with the sensor. In an embodiment, the ions may be provided from a plasma that is generated in the chamber or by a plasma that is fluidically coupled to the chamber (e.g., a remote plasma).

In an embodiment, the process 780 may continue with operation 783, which comprises applying a scaling factor to the ion transmission value. In an embodiment, the scaling factor is determined through a calibration process. For example, the calibration process may be similar to the process 670 described above. The calibration process may provide the scaling factor, and the scaling factor is associated with the sensor. In embodiments with a plurality of sensors, each of the sensors may be associated with different scaling factors. Each sensor's measured ion transmission value may then be multiplied by the associated scaling factor for that particular sensor.

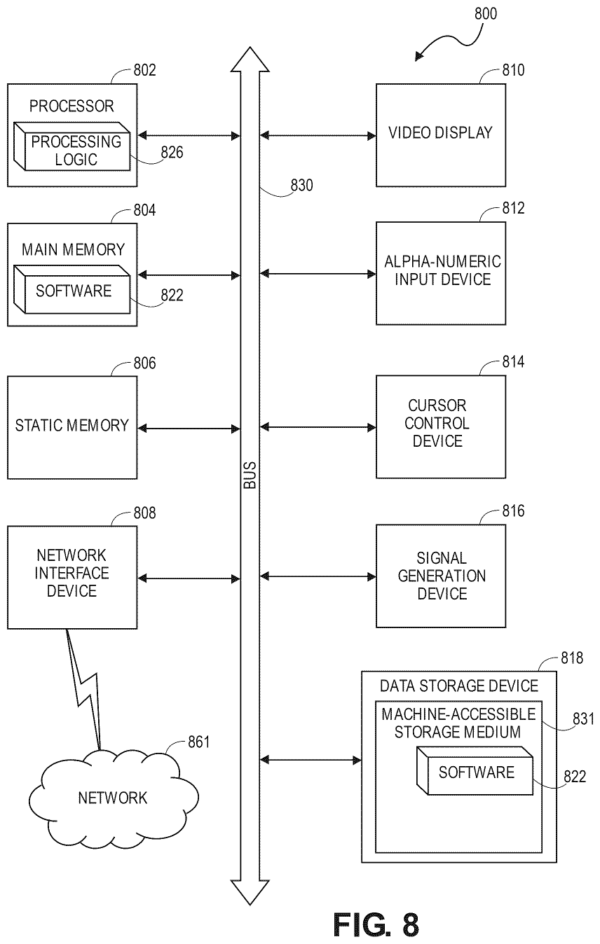

Referring now to FIG. 8, a block diagram of an exemplary computer system 800 of a processing tool is illustrated in accordance with an embodiment. In an embodiment, computer system 800 is coupled to and controls processing in the processing tool, such as semiconductor processing tool 500 in FIG. 5.

Computer system 800 may be connected (e.g., networked) to other machines in a Local Area Network (LAN), an intranet, an extranet, or the Internet. Computer system 800 may operate in the capacity of a server or a client machine in a client-server network environment, or as a peer machine in a peer-to-peer (or distributed) network environment. Computer system 800 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 800, the term “machine” shall also be taken to include any collection of machines (e.g., computers) that individually or jointly execute a set (or multiple sets) of instructions to perform any one or more of the methodologies described herein.

Computer system 800 may include a computer program product, or software 822, having a non-transitory machine-readable medium having stored thereon instructions, which may be used to program computer system 800 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 800 includes a system processor 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a secondary memory 818 (e.g., a data storage device), which communicate with each other via a bus 830.

System processor 802 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 802 may also be one or more special-purpose processing devices such as an application specific integrated circuit (ASIC), a field programmable gate array (FPGA), a digital signal system processor (DSP), network system processor, or the like. System processor 802 is configured to execute the processing logic 826 for performing the operations described herein.

The computer system 800 may further include a system network interface device 808 for communicating with other devices or machines. The computer system 800 may also include a video display unit 810 (e.g., a liquid crystal display (LCD), a light emitting diode display (LED), or a cathode ray tube (CRT)), an alphanumeric input device 812 (e.g., a keyboard), a cursor control device 814 (e.g., a mouse), and a signal generation device 816 (e.g., a speaker).

The secondary memory 818 may include a machine-accessible storage medium 831 (or more specifically a computer-readable storage medium) on which is stored one or more sets of instructions (e.g., software 822) embodying any one or more of the methodologies or functions described herein. The software 822 may also reside, completely or at least partially, within the main memory 804 and/or within the system processor 802 during execution thereof by the computer system 800, the main memory 804 and the system processor 802 also constituting machine-readable storage media. The software 822 may further be transmitted or received over a network 861 via the system network interface device 808. In an embodiment, the network interface device 808 may operate using RF coupling, optical coupling, acoustic coupling, or inductive coupling.

While the machine-accessible storage medium 831 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure calibration systems for retarding energy analyzer sensors.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. A method of calibrating a device sensor, comprising:
inserting a reference sensor into a calibration system, wherein the calibration system comprises:
a light source; and
a photonic detector;
measuring a reference transmission value of an amount of light from the light source that is transmitted through the reference sensor towards the photonic detector;
inserting the device sensor into the calibration system;
measuring a transmission value of the amount of light from the light source that is transmitted through the device sensor towards the photonic detector; and
calculating a scaling factor for the device sensor, wherein the scaling factor equalizes the transmission value of the device sensor to the reference transmission value of the reference sensor.

2. The method of claim 1, wherein the device sensor is a retarding energy analyzer sensor.

3. The method of claim 2, wherein a collector plate of the retarding energy analyzer sensor is removed before the device sensor is inserted into the calibration system.

4. The method of claim 1, wherein the device sensor is positioned between the light source and the photonic detector.

5. The method of claim 1, wherein the light source and the photonic detector are adjacent to a same end of the device sensor.

6. The method of claim 1, wherein the calibration system comprises an alignment block, and wherein the reference sensor and the device sensor are inserted into the alignment block.

7. The method of claim 1, wherein the reference sensor and the device sensor have a same structure, and wherein the device sensor has been exposed to one or more plasma processes.

8. The method of claim 1, wherein the calibration system further comprises:
an aperture between the light source and a location for inserting the device sensor, wherein a first diameter of an opening of the aperture is smaller than a second diameter of an opening in the device sensor.

9. The method of claim 1, wherein the light source comprises a light emitting diode (LED), a laser, a halogen bulb, or a heated light source, wherein the light source emits electromagnetic radiation at an ultraviolet frequency, a visible light frequency, and/or an infrared frequency, and wherein the photonic detector comprises a photo diode, a photo conductor, or a thermopile.

10. The method of claim 1, wherein the calibration system further comprises:
a collimator between the light source and a location for inserting the device sensor; and
an optical filter between the location for inserting the device sensor and the photonic detector.

11. A method for measuring a plasma property with a sensor device, comprising:
inserting the sensor device for measuring the plasma property into a chamber, wherein the sensor device comprises a sensor;
measuring an ion transmission value with the sensor; and
applying a scaling factor to the ion transmission value, wherein the scaling factor is determined through a calibration process.

12. The method of claim 11, wherein the scaling factor and the ion transmission value are multiplied with each other.

13. The method of claim 11, wherein the sensor is a retarding energy analyzer sensor.

14. The method of claim 11, wherein the calibration process uses a light source and a photonic detector to determine a transmission value of an amount of light from the light source that is transmitted through the sensor.

15. The method of claim 11, wherein the sensor device has a form factor compatible with automated movement throughout a processing tool.

16. The method of claim 11, wherein the sensor device comprises a plurality of sensors, and wherein a different scaling factor is applied to each of the plurality of sensors.

17. An apparatus, comprising:
a plurality of plates that are electrically conductive, wherein each of the plurality of plates comprises a grid of openings, wherein the plurality of plates are arranged in a stack, and wherein the plurality of plates are electrically insulated from each other; and
a board detachably coupled to the plurality of plates, and wherein the board is coupled to a collector plate that is electrically conductive.

18. The apparatus of claim 17, wherein the board is detachably coupled to the plurality of plates by a snap, a clip, a clamp, a screw, a bolt, a magnet, an adhesive, or a frame.

19. The apparatus of claim 17, wherein the plurality of plates are configured to be held at different voltages.

20. The apparatus of claim 17, wherein the apparatus is a retarding energy analyzer sensor.
